(19) United States
(12) Patent Application Publication
(10) Pub. No.: US 2021/0327172 A1
(43) Pub. Date: Oct. 21, 2021

(54) DEVICE COMPRISING AT LEAST ONE COMPONENT ACCOMMODATION, MOTOR VEHICLE AND METHOD FOR OPERATING A DEVICE COMPRISING AT LEAST ONE COMPONENT ACCOMMODATION

(71) Applicant: AUDI AG, Ingolstadt (DE)

(72) Inventors: Eike FRAUNHOFER, Eching (DE); Roland BIBERGER, Loiching (DE)

(73) Assignee: AUDI AG, Ingolstadt (DE)

(21) Appl. No.: 17/210,988

(22) Filed: Mar. 24, 2021

(30) Foreign Application Priority Data
Apr. 20, 2020 (DE) 10 2020 110 644.0

(51) Int. Cl. G07C 5/08; G07C 5/00; B60L 58/10

(52) U.S. Cl. CPC G07C 5/0816; B60L 58/10; G07C 5/085; G07C 5/006

(57) ABSTRACT

A device including at least one component accommodation, at least one exchangeable component arranged in the component accommodation, and a control unit. The exchangeable component includes a security device with a memory in which individualization information individually characterizing the component is stored. At least the memory of the security device is a non-nondestructively separable constituent part of the component The security device is connected via a communication connection to the control unit, and the control unit is configured to detect an exchange of the component based on the individualization information and on an acceptability information stored in the control unit, which describes the individual components that are acceptable for an operation of the device.

### FIELD

The disclosure relates to a device comprising at least one component accommodation, at least one exchangeable component arranged in the component accommodation, and a control unit. The disclosure further relates to a motor vehicle and to a method for operating a device comprising at least one component accommodation, at least one exchangeable component arranged in the component accommodation, and a control unit.

### BACKGROUND

In devices which comprise one or more exchangeable components, it can be desirable for security reasons to prevent installation of unsuitable exchange components that may represent a security risk. However, at the same time, it is also desirable that as many individual components of a device as possible are kept exchangeable, for example, in order to avoid, in the case of a repair of a defect of a component, an exchange of additional components and/or of other constituent parts of the device which, for example, are not affected by the defect to be repaired. This relates, for example, to motor vehicles comprising a plurality of different components which have to be exchanged over the lifetime of the vehicle under certain circumstances or repaired in the case of a defect. In other devices as well, for example, in an energy storage device which comprises multiple battery modules, an exchange of individual battery modules can be necessary. Here, a monitoring of an exchange is desirable in each case, so that an unauthorized exchange of a component possibly representing a security risk can be recognized. From the prior art, different function monitoring systems of battery storage devices or other devices are known.

In WO 2019/028451 A1, a battery monitoring system is described, in which different properties of battery cells of a battery storage device are acquired and stored. Selected properties for individual battery cells can here be received and stored by a central battery management system via a wireless network.

US 2007/0216368 A1 describes a system for cell balancing of individual energy cells of an energy storage device. Here, a safety circuit which communicates with the individual battery cells is provided. Moreover, a channel for outputting and/or receiving data of an apparatus which uses the energy storage device is provided.

In DE 199 12 780 A1, an arrangement for a security module for a franking machine is described. The security module here comprises a battery as well as means for supplying an apparatus with a system voltage. The battery here is exchangeable, wherein, via a voltage monitoring unit of the security module, a resettable self-preservation is possible, which is triggered when the battery voltage drops below a predetermined threshold. This can counteract a manipulation of the apparatus by changing a battery voltage, while still enabling an exchange of the battery of the security module.

### SUMMARY

The underlying aim of the disclosure is to specify an improved device with an exchangeable component, which can in particular detect an unacceptable exchange of a component and make such an unacceptable exchange more difficult or prevent it.

To achieve this aim, in a device of the type mentioned at the beginning, it is provided according to the disclosure that the exchangeable component comprises a security device with a memory in which individualization information individually characterizing the component is stored, wherein at least the memory of the security device is a non-nondestructively separable constituent part of the component, wherein the security device is connected via a communication connection to the control unit, and the control unit is configured to detect an exchange of the component based on the individualization information and an acceptability information stored in the control unit, which describes the individual components that are acceptable for operation of the device.

The control unit of the device can be designed, for example, to control one or more functions of the device. In addition, the control unit communicates directly or indirectly with the security devices, each of which forms a constituent part of the component, at least when the at least one component is inserted in the corresponding component accommodation of the device. It is possible that the security device comprises, in addition to the memory, additional constituent parts, for example, a communication system designed for communication with the control unit. By means of the individualization information stored in the memory of the security device, the respective component is individually characterized. The control unit can read out the individualization information of the at least one component of the device via the communication connection and compare it with the acceptability information stored in the control unit. By means of this comparison, it can be detected whether a component inserted in the component accommodation of the device is acceptable for a further operation of the device, and therefore whether an authorized exchange of the component has occurred. The acceptability information stored in the control unit can be generated, for example, by teaching the control unit about the at least one component of the device. In particular, it can be provided that such teaching is possible only if a security key or the like is known, so that a change or an updating of the acceptability information is only feasible in connection with an acceptable exchange of a component.

At least the memory of the security device is a non-nondestructively separable constituent part of the component, so that at least the memory of the security device cannot be separated from a removed component in order to install it on a component that is not acceptable for the operation of the device and insert this component, for the exchange of the removed component, in the component accommodation of the device.

The fact that at least the memory of the storage device is a non-nondestructively separable constituent part of the component in this context means in particular that, with removal of the memory, for example, of the security device from the component, at least the memory containing the individualization information is destroyed and/or that the security device or the memory of the security device cannot be removed without destruction of the component, and, in particular, it can also not be inserted in the component accommodation without destruction of a component which can be inserted into the component accommodation but which is not acceptable. An unauthorized exchange of a component by installation of the security device of an acceptable component in an unacceptable component is made impossible or at least made considerably more difficult thereby, so that an exchange of an acceptable component by an unacceptable component can be effectively counteracted. In this manner, an unauthorized installation protection for the device or at least one component thereof is achieved.

Moreover, it advantageously becomes possible that, in case of a defect or the like, only the security device comprising the memory has to be exchanged along with the component. By means of the memory which is implemented as a non-nondestructively separable constituent part of the device or by means of the security device which is implemented as a non-nondestructively separable component of the device, the individualization of the component generated by the individualization information becomes an intrinsic constituent part of the component itself. Therefore, no additional elements for the individualization of the component are necessary, which would have to be exchanged in the case of a defect. Thus, in case of an exchange of the component, additional parts of the device remain in the device, since they do not need to be exchanged along with it, so that, advantageously, for example, in the case of a defect of the component, no parts of the device that are not defective per se need to be exchanged along with it.

Particularly advantageously, this principle can be used in an energy storage device which comprises one or more battery modules as component. The energy storage device can, for example, be a high-voltage battery for an electrified vehicle, that is to say for a motor vehicle which can be driven by an electric motor. The battery modules here can contain multiple battery cells in each case. By means of the security devices implemented in each case as a non-nondestructively separable constituent part of a battery module, the individualization information of the battery modules of the energy storage device can be read out, for example, by a common control unit, for example, by a battery control apparatus, and compared with the acceptability information stored in the control unit, in order to detect an exchange of a battery module.

However, the disclosure can here be used not only in an energy storage device comprising at least one battery module, but also can be used advantageously in other devices comprising at least one component arranged in a component accommodation as well as a control unit. Here it is possible, in particular, that the device is a motor vehicle or that the device is a part of a motor vehicle.

In a preferred embodiment of the disclosure, it can be provided that at least the memory of the security device is arranged in an interior of the component so that it cannot be accessed from outside, and/or that at least the memory of the security device is attached to the component in such a manner that separation of the memory leads to destruction of the memory and/or of the stored individualization information. Thus, an unauthorized exchange of the component, a retrofitting of the security device or of the memory of the security device to a component which is not acceptable per se carried out in order to thwart exchange monitoring by the control unit can advantageously be prevented.

In particular, it can be provided that the security device or at least the memory of the security device is, for example, molded, welded or glued on or in the component. It is also possible that at least the memory of the security device is arranged in the interior of the component in such a manner that, for the removal of the security device or of the memory thereof, the component has to be destroyed, and an insertion of the security device or of its memory into an another component which is of substantially of identical design but not acceptable is also not possible without also destroying the other component.

According to the disclosure, it can be provided that the individualization information is or comprises a serial number and/or a security parameter relating to a security function of the component and/or at least one calibration parameter relating to a calibration of the component and/or at least one historical information describing a history of the component. The respective information used as individualization information in each case enables, alone and/or in combination, an individualization of the component comprising the security device. In this manner, it is possible that a component present in the device can be distinguished from other components of identical design. In particular, the acceptability information which is stored in the control unit of the device can in each case contain the information corresponding to the information stored as individualization information, so that a verification of the acceptability of a component inserted in the device is possible, in a simple manner.

In order to make manipulations in the case of an exchange of the component even more difficult, it can be provided according to the disclosure that the communication connection is designed to carry out a secured communication between the security device and the control unit. In this manner, it is thus possible to prevent a transmission of the individualization information to the control unit or a retrieval of the individualization information from the memory of the security device by the control unit from being influenced, in particular during the exchange of a component.

In a preferred embodiment of the disclosure, it can be provided that the component is connected, in particular separably, to a component control apparatus which is configured to carry out and/or monitor at least one function of the component. The monitoring of the exchange of a component by the central control unit of the device advantageously enables the control of the component via a separably connected component control apparatus which is arranged in particular in the vicinity of the component and connected to the component via a plug connection. Thus, an integration of the component control apparatus in the component can be dispensed with. This advantageously enables an exchange of the component control apparatus without having to carry out an exchange of the component and vice versa.

In particular, in case of a device designed as energy storage device, this enables exchanging individual battery modules separately from a module control apparatus associated in each case with the battery module as component control apparatus. If a defect occurs in the module control apparatus, it is thus advantageously possible to exchange just the module control apparatus. At the same time the battery module can also nevertheless advantageously be protected against an unacceptable exchange.

According to the disclosure, it can be provided that the communication connection comprises a connection of the security device to the component control apparatus and a connection of the component control apparatus to the control unit. In this manner, advantageously, a wiring complexity within the device can be reduced, since the at least one component can be connected to the component control apparatus thereof, and a communication of the control unit with the security device via the component control apparatus can occur. Moreover, a communication and/or a control of the component control apparatus by the control unit is also enabled.

According to the disclosure, it can be provided that the component control apparatus is formed by an application-specific integrated circuit (ASIC). This enables a cost-effective implementation of the component control apparatuses, which is advantageous in particular in devices comprising a plurality of components with respective associated component control apparatuses.

In a preferred embodiment of the disclosure, it can be provided that at least one section of the communication connection is implemented as a single-wire connection. In particular, a connection between the component control apparatus and the control unit can be implemented as a single-wire connection. A connection of the security device to the control unit via a single-wire connection is also possible. This has the advantage that the wiring complexity for producing the device can be reduced. A common ground potential of the device, for example a housing of an energy storage device, a module ground of at least one of the battery modules and/or a body of a motor vehicle here forms, in particular, a return conductor of the single-wire connection.

According to the disclosure, it can be provided that the memory of the security device is implemented as an electronically erasable programmable read-only memory (EEPROM). This advantageously enables in each case the integration of the memory of the security device in different types of components as a non-nondestructively separable constituent part of the component. For example, a memory implemented as EEPROM can be arranged in the interior of an energy storage module, in particular in or between the energy storage cells of the energy storage module.

In a preferred embodiment of the disclosure, it can be provided that the control unit is designed to undertake at least one measure after detection of a component exchange. For example, it is possible that, after an authorized exchange, only a monitoring of the removal of the new component occurs. When a component of the device is exchanged with an unacceptable component, a measure can be undertaken in response. For example, a function of the unacceptable component can be suppressed during operation of the device. The entire device can also be put out of operation or a startup of the device can be prevented. Additionally or alternatively, it is possible that, in particular in case of an unacceptable component exchange, advice is issued to an output device of the device and/or to an another control apparatus connected to the control unit of the device. Additionally or alternatively, the storage of information in a memory of the control unit is also possible.

In a preferred embodiment of the disclosure, it can be provided that the component is a battery module comprising at least one battery cell and/or that the control unit is a battery control apparatus and/or that the component is a headlight and/or that the control unit is a headlight control unit. The device can be a battery comprising in particular multiple battery modules, in particular a traction battery of a motor vehicle. The at least one battery module here can be inserted into a module accommodation of the energy storage device. The security device or the memory of the security device here is implemented as non-nondestructively separable constituent part of the at least one battery module. In particular, the security device or the memory thereof can be arranged in an interior of a battery module and not be accessible from outside.

It is also possible that the component is a headlight, in particular a headlight of a motor vehicle, which is inserted in a headlight accommodation as component accommodation. The control unit can here be designed, for example, as a headlight control unit which controls a function of the device comprising at least one headlight.

For a motor vehicle according to the disclosure, it is provided that it comprises a device according to the disclosure. The device can in particular be an energy storage device comprising multiple battery modules as components, in particular a traction energy storage device, of the motor vehicle. Additionally or alternatively, it is also possible that the device comprises, for example, a lighting device of the motor vehicle, which comprises at least one headlight as component as well as at least one headlight accommodation as component accommodation and a headlight control unit.

All the above advantages and embodiments described in connection with the device according to the disclosure correspondingly also apply to the motor vehicle according to the disclosure.

For a method according to the disclosure for operating a device comprising at least one component accommodation, at least one exchangeable component arranged in the component accommodation, and a control unit, it is provided that the exchangeable component comprises a security device with a memory in which individualization information individually characterizing the component is stored, wherein at least the memory of the security device is a non-nondestructively separable constituent part of the component, wherein the security device is connected via a communication connection to the control unit, wherein an exchange of the component is detected by the control unit based on the individualization information and an acceptability information stored in the control unit, which describes the individual components that are acceptable for an operation of the device.

All the advantages and embodiments described in connection with the device according to the disclosure or with the motor vehicle according to the disclosure correspondingly also apply to the method according to the disclosure.

### BRIEF DESCRIPTION OF THE FIGURES

Additional advantages and embodiments of the disclosure result from the embodiment examples described below and in reference to the drawings. The drawings are diagrammatically representations and show:

FIG. 1 a first embodiment example of a device according to the disclosure, and

FIG. 2 an embodiment example of a motor vehicle according to the disclosure, comprising a second embodiment example of a device according to the disclosure.

### DETAILED DESCRIPTION

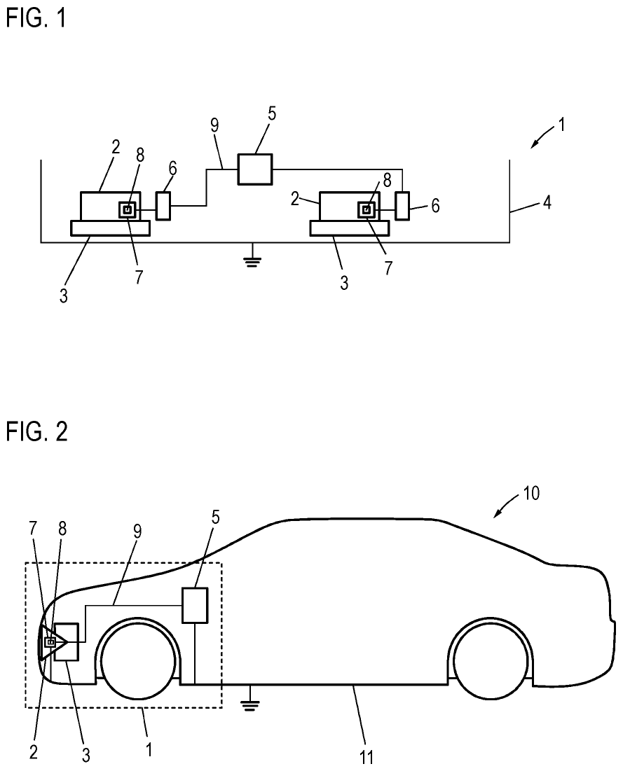

In FIG. 1, a first embodiment example of a device 1 according to the disclosure is shown. The device 1 here is implemented as an energy storage device, in particular an energy storage device designed for use as traction battery in a motor vehicle. The device 1 comprises multiple components 2 implemented as battery modules which are each arranged in a component accommodation 3 of the device 1, which is implemented as battery module accommodation. The device 1 moreover comprises a common housing 4 and a control unit 5.

A component control apparatus 6 is associated with each of the components 2 implemented as battery modules. The component control apparatus 6 is designed here as a module control apparatus and is arranged in spatial proximity of the component 2. The component control apparatus 6 and the component 2 are here connected via a plug connection.

The components 2 each comprise a security device 7 with a memory 8, wherein the security devices 7, in particular the memory 8 of the security devices 7, are each a non-nondestructively separable constituent part of the components 2. Here, the memory 8 and/or additional components of the security device 7 is/are arranged in an interior of the components 2 designed as battery modules, for example, within or between the energy storage cells of the battery modules. Additionally or alternatively, it can in particular be provided that the memory 8 and/or additional components of the security device 7 is/are, for example, welded, glued and/or molded onto additional constituent parts of the component 2. The security devices 7 or the memories 8 of the security devices 7 are arranged in the interior of the component 2 in such a manner that they are not accessible from outside. The attempt to remove the security device 7 and in particular the memory of the security device 7 leads to destruction of the security device 7 or of the memory 8 and/or of the component 2, so that a removal of the security device 7 or of the memory 8 thereof from the component 2 and the installation in another component of substantially identical design, which can be inserted into the component accommodation 3, is not possible.

In the memory 8, individualization information individually characterizing the component 2 is stored in each case. This individualization information comprises a serial number and/or at least one security parameter relating to a security function of the component 2 and/or at least one calibration parameter relating to a calibration of the component and/or at least one historical information describing a history of the component. The individualization information here enables an individual characterization of the component 2, so that it can be distinguished from other components of identical design.

The security device 7 is connected to the control unit 5 via a communication connection 9. The communication connection 9 comprises a section, implemented as single-wire connection, between the security device 7 and the component control apparatus 6. The component control apparatus 6 is connected to the central control unit 5 of the device 1 via an additional section of the communication connection 9. A common ground potential of the device 1, for example, the housing 4 of the device 1 and/or the module grounds of the battery modules, forms a return conductor of the communication via the single-wire connection. It is possible that the section of the communication connection 9 between the component control apparatus 6 and the control unit 5 is also implemented as a single-wire connection. Via the communication connection 9 or via the connection between the security device 7 and the component control apparatus 6, the control unit 5 can communicate with the security device 7 and read out the individualization information in the memory 8. The communication between the control unit 5 and the security device 7 here occurs via a secured communication which prevents an unauthorized intervention in the communication from outside in particular during the exchange of a component 2.

In the control unit 5, acceptability information is moreover stored, which describes the individual components 2 that are acceptable for an operation of the device 1. Based on the individualization information of the individual components 2 and the acceptability information stored in the control unit 5, an exchange of the components 2 can be detected by the control unit 5. In this manner it is possible to detect an unacceptable exchange of the components 2 and thus also an unacceptable exchange of a battery module of the energy storage device. The acceptability information stored in the control unit 5 can in particular be stored in such a manner that it can be changed only under certain conditions, for example, when a security key is known, and/or taught to the components 2 present in the device 1.

The components 2 are connected to the component control apparatus 6 via a detachable connection, in particular a plug connection. This makes it possible that the components 2 can be exchanged independently of the component control apparatus 6 which is configured to carry out and/or monitor at least one function of the component 2. By means of the component control apparatuses 6 designed as module control apparatuses, for example, individual parameters of the component 2 implemented as battery module can be monitored for an operation of the energy storage device and/or can be transmitted to the control unit 5 via the communication connection 9. For example, by means of the component control apparatus 6, a voltage, a charge state, a temperature or the like of the component 2 can be monitored. By verifying the exchange of the component 2 with the help of the security device 7 introduced into the component 2 as a non-nondestructively separable constituent part of the component 2, it becomes advantageously possible that, in the case of a defect of the component control apparatus 6, it is possible to exchange only said component control apparatus without an exchange of the components 2 also being necessary. In the case of an exchange of a component 2, the exchange of the component control apparatus 6 can also be dispensed with.

The component control apparatuses 6 are each implemented as an application-specific integrated circuit (ASIC). The memories 8 of the security devices 7 integrated in the components 2 are each implemented as an electrically erasable programmable read-only memory (EEPROM). It is possible that the security devices 7, in addition to the memory 8, moreover comprise other constituent parts, for example, a communication device designed for a communication with the control unit 5.

The control unit 5 is moreover configured to undertake a measure after detection of a component exchange. Here, it can be provided that, in the case of an exchange of one of the components 2 determined to be acceptable by the control unit 5, the component 2 then newly inserted into the device 1 is monitored with regard to an exchange. In the case of an unauthorized exchange, that is to say the insertion of a component 2 implemented as battery module in the accommodation 3 which does not comprise a memory 8 with individualization information which is considered to be acceptable, it can be provided, for example, that the functioning of the component 2 during operation of the device 1 is suppressed. Additionally or alternatively, it is also possible that the functioning of the entire device 1 designed as energy storage device is suppressed and/or limited. Additionally or alternatively, it is possible that advice is issued by the control unit 5 to an output device (not shown here) connected to the control unit 5 or to an another control apparatus connected to the control unit 5, or the like. It is also possible that information describing the unacceptable exchange is stored in a memory of the control unit 5.

In FIG. 2, an embodiment example of a motor vehicle 10 according to the disclosure is represented, which comprises a second embodiment example of a device 1 according to the disclosure. The device 1 comprises at least one component 2 designed as headlight, which is inserted into a component accommodation 3 designed as headlight accommodation. The component 2 comprises a security device 7 with a memory 8, wherein the memory 8 or the security device 7 is implemented as a constituent part of the component 2, which cannot be non-nondestructively separated from the component 2. Here, the memory 8 and/or other constituent parts of the security device are arranged in an interior of the component 2 so that they are not accessible from outside. Here the memory 8 and/or other constituent parts of the component 2 are, for example, molded, welded or glued to one another. In this embodiment example, the security device 7 is directly connected via the communication connection 9 implemented as single-wire connection to the control unit 5 designed as headlight control unit. In this case, a common ground potential which in this embodiment example is a body 11 of the motor vehicle 10 forms the return line. By means of the control unit 5, for example, an operation of the component 2 designed as headlight can occur.

Analogously to the above embodiments, with regard to the first embodiment example of the device 1, the control unit 5 is designed to carry out a method according to the disclosure so that it can detect an unauthorized exchange of the components designed as headlights 2 and take appropriate measures. It is possible that the device 1 comprises additional components 2 designed as headlights and/or other components 2 of the motor vehicle that are each arranged in a component accommodation 3, wherein these components 2 each also comprise a security device 7 with a memory 8, wherein at least the memory 8 is implemented as a non-nondestructively separable constituent part of the component 2.

1. A device, comprising: at least one component accommodation, at least one exchangeable component arranged in the component accommodation, and a control unit, wherein the exchangeable component includes a security device with a memory in which individualization information individually characterizing the component is stored, wherein at least the memory of the security device is a non-nondestructively separable constituent part of the component, wherein the security device is connected via a communication connection to the control unit, and the control unit is configured to detect an exchange of the component based on the individualization information and on acceptability information stored in the control unit, which describes the individual components that are acceptable for an operation of the device.

2. The device according to claim 1, wherein at least the memory of the security device is arranged in an interior of the component so that it is not accessible from outside and/or wherein at least the memory of the security device is attached to the component in such a manner that separation of the memory leads to a destruction of the memory and/or of the stored individualization information.

3. The device according to claim 1, wherein the individualization information is or includes a serial number and/or at least one security parameter relating to a security function of the component and/or at least one calibration parameter relating to a calibration of the component and/or at least one historical information describing a history of the component.

4. The device according to claim 1, wherein the communication connection is designed for carrying out a secured communication between the security device and the control unit.

5. The device according to claim 1, wherein the component is connected, in particular separably connected, to a component control apparatus which is configured to carry out and/or to monitor at least one function of the component.

6. The device according to claim 5, wherein the communication connection includes a connection of the security device to the component control apparatus and a connection of the component control apparatus to the control unit.

7. The device according to claim 5, wherein the component control apparatus is formed by an application-specific integrated circuit (ASIC).

8. The device according to claim 1, wherein at least one section of the communication connection is implemented as a single-wire connection.

9. The device according to claim 1, wherein the memory of the security device is implemented as an electrically erasable programmable read-only memory (EEPROM).

10. The device according to claim 1, wherein the control unit is designed to undertake at least one measure after detecting a component exchange.

11. The device according to claim 1, wherein the component is a battery module comprising at least one battery cell and/or in that the control unit is a battery control apparatus and/or in that the component is a headlight and/or in that the control unit is a headlight control unit.

12. A motor vehicle comprising a device according to claim 1.

13. A method for operating a device comprising at least one component accommodation, at least one exchangeable component arranged in the component accommodation, and a control unit, wherein the exchangeable component includes a security device with a memory in which individualization information individually characterizing the component is stored, wherein at least the memory of the security device is a non-nondestructively separable constituent part of the component, wherein the security device is connected via a communication connection to the control unit, wherein an exchange of the component is detected by the control unit based on the individualization information and on an acceptability information stored in the control unit, which describes the individual components that are acceptable for an operation of the device.

14. The device according to claim 2, wherein the individualization information is or includes a serial number and/or at least one security parameter relating to a security function of the component and/or at least one calibration parameter relating to a calibration of the component and/or at least one historical information describing a history of the component.

15. The device according to claim 2, wherein the communication connection is designed for carrying out a secured communication between the security device and the control unit.

16. The device according to claim 3, wherein the communication connection is designed for carrying out a secured communication between the security device and the control unit.

17. The device according to claim 2, wherein the component is connected, in particular separably connected, to a component control apparatus which is configured to carry out and/or to monitor at least one function of the component.

18. The device according to claim 3, wherein the component is connected, in particular separably connected, to a component control apparatus which is configured to carry out and/or to monitor at least one function of the component.

19. The device according to claim 4, wherein the component is connected, in particular separably connected, to a component control apparatus which is configured to carry out and/or to monitor at least one function of the component.

20. The device according to claim 6, wherein the component control apparatus is formed by an application-specific integrated circuit (ASIC).
